(19) United States
(12) Patent Application Publication
(10) Pub. No.: US 2014/0344023 A1
(43) Pub. Date: Nov. 20, 2014

(54) Methodology and Process to Price Benchmark Bundled Telecommunications Products and Services

(71) Applicants: Samuel Shin Wai Chiu, Stanford, CA (US); Jean Pascal Crametz, Mountain View, CA (US)

(72) Inventors: Samuel Shin Wai Chiu, Stanford, CA (US); Jean Pascal Crametz, Mountain View, CA (US)

(73) Assignee: Oncept, Inc., Palo Alto, CA (US)

(21) Appl. No.: 13/895,020

(22) Filed: May 15, 2013

(51) Int. Cl. G06Q 30/02

(52) U.S. Cl. CPC G06Q 30/0206
USPC 705/7.35

(57) ABSTRACT

This invention relates generally to a system and method to provide price benchmark for a bundled product consisting of two or more components, with particular application in telecommunications products/services. Benchmarking bundled services usually revolves around choosing a price distribution quantile of (near) identical bundled transactions. Historical transaction data lacks sufficient volume to extract reliable statistical information to price benchmark bundled telecommunications services of “similar” nature (typically includes triplets of access, port/plug and CustomerPremisesEquipment). An alternative, Component Based Model (CBM), approach sums the price quantile of each component in the bundle. The advantage of CBM is that price data by network element is more abundant providing acceptable statistical reliability. The drawback is that the sum of quantile values usually underestimates the quantile of the sum. This invention presents a method and procedure to modify CBM to provide an accurate quantile value representing a Full Cost bundled product.

### TECHNICAL FIELD

This invention relates generally to providing a transparent methodology and process to establish a fair pricing benchmark for telecommunications product and service bundles. Such bundles typically consist of access, transport and routers, which we shall generically refer to as WAN (Wide Area Network) service. The bundle price benchmark described herein includes, but not limited to, WAN service and is applicable to other bundled pricing benchmark where insufficient composite transactions data prevents the construction of a reliable statistics for such benchmarking purposes. A fair pricing benchmark is important to both the suppliers (carriers) and corporate buyers to avoid buyer/seller remorse: fearfully of paying too much for the buyers and receiving too little for the suppliers—psychologically and after a contract is signed. Any credible benchmark pricing methodology requires a sufficiently large set of completed and timely transactional data to accurately reflect the market price of telecommunications products and service. Benchmarking the exact bundling characteristics (with identical/similar speed, distance, geographical location, quantity and duration of service) in any single contract negotiation is particularly challenging. To meaningfully price benchmark in a single geographical location for a bundled WAS service would require over 100,000 data points for a “typical” Fortune 500 company. The methodology created herein uses price data (of actual transactions) of single network element (access, transport or router) one at a time, to be intelligently combined so that it will be fair for both supplier and buyer. The methodology and process herein overcome the curse of data insufficiency.

### BACKGROUND OF INVENTION

Benchmarking WAN services usually revolves around choosing a price distribution quantile of completed transactions of “similar” identical services. For example, a 25%-price-quantile represents the price point such that it is above 25% of all actual transactions. A typical WAN contract consists of three network elements: access, port/plug and CPE (Customer Premise Equipment). As one embodiment of the invention, we will use these triplets of network elements in our description herein with the straightforward extension being applied to include other types of telecommunications service contracts as well as other non-telecommunications products and services.

When there is sufficient data (to match the bundle characteristics and geographical location under negotiation), a common practice is to use a particular quantile (e.g., the 20% quantile) as a price benchmark: a transaction price that is above at least 20% of all transaction prices.

In any price benchmark exercise, it is imperative to have a reliable set of transaction price data points in the form of a credible distribution, i.e., a histogram of transaction price points for identical WAN bundle and at the same geographical region. It is often difficult for a contract counterparty to produce a credible and fair price acceptable to the other party. There is the need to have sufficient transaction price data to match not only the characteristics of the bundle but also the geographical location. Insufficient data renders any statistical price inference meaningless.

There are two competing quantile-based methodologies to price benchmark WAN bundles: Full Cost Comparator Model and Component Based Model.

The Full Cost Comparator Model aims to use recent price data of “similar” nature (similar/identical WAN bundles) and at the same geographies. The necessary data set requires a large volume of actual transactions. Finding valid full cost comparators that have identical (or even similar) configurations as the one being benchmarked would require the comparator company to have thousands of different configurations available for each company. Such requirement is much more than the average number of sites a “typical” Fortune 500 company would have.

The data-certified accuracy provided by the Full Cost Comparator Model is attractive IF sufficient transaction data is available. Data complexity requires bundled prices of network elements. The enormous data requirement precludes its implementation. Extracting sufficient and usable information from full cost comparator price statistics of “similar” nature (which typically includes triplets of access, port/plug and Customer Premises Equipment, CPE, in each completed transaction) requires a large quantity of data.

FIG. 1 contains an example showing some possible “standard combinations”. The possible combinations for site in this example would require over 100,000 data point for each country.

To overcome the lack of sufficient transaction data, practitioners attempt to expand data set by aggregation.

We will use access capacity to illustrate the data expansion approach. Suppose one needs price data for 1M access capacity. To augment the limited number of transactions for 1M access capacity, one would use transaction data for other access capacities (e.g., 2M and 3M).

One commonly practiced approach is to create a single (expanded) data set by pooling transaction prices of all capacity categories using some scaling scheme.

It is not appropriate to divide the transaction price points for the 2M transactions by two to obtain the per unit (1M) price because there is usually some implied volume discount: the per unit capacity price of 1M capacity is the usually the most expensive with the per unit price of 3M capacity being the lowest. Each set of (specific capacity) data is not sufficient (in quantity) to be used for price benchmarking.

Because of volume discount, the per unit price for different capacity types have to be appropriately scaled so that all per unit prices are somewhat “normalized” to a base capacity type.

There are different ways to scale, based on what reference statistics is used. Scaling by a reference statistics will result in a pooled data set.

The scaling method works by choosing: (1) a base capacity to which completed transaction price points of a different capacity will be scaled, and (2) a reference statistics (e.g., a specific quantile or the mean).

The scaling constant (form one capacity to the base capacity) equals the ratio of the respective reference statistics of the base capacity to other capacity types. For examples:

Scale by quantile: the base capacity has a 20% price quantile of 60 (unit cost of capacity) and capacity (indexed by) k has a 20% price quantile of 40: scaling constant=60/40=1.5.

Scale by mean: the base capacity has a mean (average) price 65 (unit cost of capacity) and capacity (indexed by) k has mean price of 37: scaling constant=65/37=1.76.

All transaction prices of capacity k will be multiplied by the respective scaling constant (depending on the chosen base capacity and the chosen reference statistics, either a quantile or its mean).

The expanded data set now contains unit capacity price transaction data comprising of all capacity type being “standardized/normalized” to the base capacity.

It is instructive to relate the scaling concept to that of currency conversion. Suppose there is an efficient market to trade currency without friction: identical buying/selling price with no transaction fee. Imagine a basket of international currencies in random denominations as written in separate pieces of paper. Transform all currencies into USD. The scaling constant is the exchange rate from currency (capacity in the case of telecommunication product/service) j to USD (as the base capacity). The random denominations in currency j are equivalent to transaction data points (of unit capacity price for capacity type j). Multiplying each price data point to bring it to the base capacity is equivalent to converting each currency j denomination into USD equivalent. After scaling, all unit price point data is standardized to capacity type j; or all monetary value in the currency basket has its USD equivalent.

The following procedure is a recipe to pool all transaction unit price data consistent with the base capacity data, using a specific quantile as the reference statistics:

Compute the q-quantile of each capacity type (e.g., 20%). They will likely be different because of volume discount. For example, the per unit capacity price is likely to be lower for the large capacity transaction pool. Denote these quantiles as Q_{20%}^{j}, for capacity type j.

Select a base capacity (for example, capacity type k). Compute the scaling constant for type j as

$${S}_{20 \%}^{j -> k} = \frac{{Q}_{20 \%}^{k}}{{Q}_{20 \%}^{j}} ,$$

for j=1, 2, T, where T is the total number of capacity types under consideration.

Multiply all per-unit price data points for capacity type j by the respective scaling constant S_{20%}^{j→k}.

We now have a pooled data set with n=Σⱼ₌₁^{T} nⱼ data points in which all per-unit prices are “normalized” to capacity type k.

When one scales by the mean/average per-unit price value, simply replace the quantile values by the mean per-unit price value by each capacity type. The resultant pooled data set will be different for different chosen reference statistics (be it a specific quantile or the mean value).

FIG. 2 shows hypothetical distributions for unit capacity price, from left to right when contract transport capacity decreases.

FIG. 3 is an accompanying table to FIG. 2. It contains their respective data frequency (percentage of pooled data points in each capacity category), the respective means/averages and the respective 20%-quantiles. The last two scaling factor rows are the computed scaling factor using the 20%-quantile or the mean as the reference statistics and with Capacity 2 as the base capacity. In actual application, the idealized distributions are replaced by the histogram of prices for each capacity type.

Using the 20%-quantile as the reference statistics, for example, each of the (unit) price point of capacity 1 (leftmost distribution) will be multiplied by 1.65 (scaled up as the ratio of 57.8 to 35.05), while all capacity 3 unit price will be multiplied by 0.63 (scaled down by the ratio of 57.8 to 91.68), etc.

FIG. 4 illustrates the effect of scaling on the hypothetical distributions examined in FIG. 2.

After (20%-quantile) rescaling, all distributions will gravitate towards the distribution of capacity 2—as described below. One can imagine:

The range (the lower limit and the upper limit) of each individual distribution/histogram will be scaled, larger if the scaling constant is larger than one and smaller otherwise. The actual shape of the distribution remains the same, but it is either stretched (scaling constant larger than one), or compressed (scaling constant less than one) as if one is manipulating the histogram/distribution drawn on a rubber sheet.

Distribution for Capacity 1 has been stretched, distributions for Capacity types 3 and 4 were compressed, while Capacity 2 distribution (the base capacity) remains unchanged.

After such normalization, we combine all the data points to form an aggregated distribution which is shown in FIG. 4. The aggregated distribution, the (thicker) solid red curve, is the weighted sum of the post-scaled distributions, weighted by the frequency of the volume of data in each capacity type j as

$${P}_{j} ≡ \frac{{n}_{j}}{{\sum }_{j = 1}^{T} {n}_{i }} ,$$

second row of the Table in FIG. 3. This solid-red hypothetical aggregated distribution has a (very) irregular shape, a consequence of the different histograms representing transaction data of different capacity types.

It would appear that pooling transactions data of different capacity types by scaling (using a reference statistics and to a base capacity) will increase the size of the dataset, thus increasing the statistical reliability of benchmarking (whether using a quantile or the average). The following theorem proves otherwise.

Theorem of False Expectation

Reference statistics scaling (using either the mean or any quantile) to a base capacity to pool all transaction data to benchmark the same reference statistics is equivalent to using only the data points of the base capacity. The implication is that we are essentially using only the base capacity transaction data while throwing away all other transaction data of different capacity types. There is absolutely no gain in pooling all transaction data in such a manner. The following lemmas are needed to prove this theorem, by defining X′=aX, with a>0. The new random variable X′ is a positive multiple of random variable X.

Scaling Property 1: E[X]=aE[X], a well known result in probability theory, the average/mean of a random variable scales exactly as that of the scaled random variable.

Scaling Property 2: Q′_{q}=aQ_{q}, where q denotes a specific quantile percentage (e.g., 20%) and Q_{q} is the quantile value at q. That is, the quantile scales identically as a random variable is scaled.

Proof of Property 2. It is well known that the distribution for X′ can be derived as:

$${f}_{{X}^{′}} ( {x}^{′} ) = \frac{1}{a} {f}_{X} ( \frac{{x}^{′}}{a} ) ,$$

where ƒₓ(x) is the distribution of the original X. The q-quantile, Q′_{q}, of X′ is defined by the equation, assuming X>0:

$$q = {\int }_{{x}^{′} = 0}^{{Q}_{q}^{′}} {f}_{{X}^{′}} ( {x}^{′} ) d {x}^{′} = {\int }_{{x}^{′} = 0}^{{Q}_{q}^{′}} \frac{1}{a} {f}_{X} ( \frac{{x}^{′}}{a} ) d {x}^{′} = {\int }_{{x}^{′} = 0}^{{Q}_{q}^{′}} {f}_{X} ( \frac{{x}^{′}}{a} ) d ( \frac{{x}^{′}}{a} ) .$$

We now make the substitution for the variable of integration:

$$\frac{{x}^{′}}{a} = y \text{:}$$

$$q = {\int }_{y = 0}^{\frac{{Q}_{q}^{′}}{a}} {f}_{X} ( y ) d y ,$$

which is simply the defining equation for the q-quantile of X:

$${\int }_{x = 0}^{{Q}_{q}} {f}_{X} ( x ) d x ≡ q = {\int }_{y = 0}^{\frac{{Q}_{q}^{′}}{a}} {f}_{X} ( y ) d y .$$

Equating the upper limits of integration, we can conclude: Q′_{q}=aQ_{q}.

Using the Scale by Quantile and Scale by Mean [0018] and Properties P1, P2, we can prove the following by recognizing/identifying the scaling constant a for each capacity type using base capacity k as S_{q}^{j→k} or S_{μ}^{j→k}.

The mean and q-quantile of capacity type j becomes:

$$a {μ}^{j} = {S}_{μ}^{j -> k} {μ}^{j} = \frac{{μ}^{k}}{{μ}^{j}} {μ}^{j} = {μ}^{k} , and$$

$$a {Q}_{q}^{j} = {S}_{q}^{j -> k} {Q}_{q}^{j} = \frac{{Q}_{q}^{k}}{{Q}_{q}^{j}} {Q}_{q}^{j} = {Q}_{q}^{k} .$$

In effect, after scaling, the reference statistics of each individual capacity type all equal that of the base capacity. We will refer these two observations as Corollary 1 and Corollary 2.

Proof of the Theorem of False Expectation

Case 1: using the mean as reference statistics to scale
After scaling, we denote the price distribution for capacity j after scaling as f′ⱼ(x), with its frequency being

$${P}_{j} ≡ \frac{{n}_{j}}{{\sum }_{j = 1}^{T} {n}_{i}} .$$

The distribution of the pooled data can be computed as: f′ₓ(x)=Σⱼ₌₁^{T} Pⱼ f′ⱼ(x) using the Law of Total Probability. Since each of the scaled distribution f′ⱼ(x) has the same mean as the base capacity (Corollary 2), we conclude:

E[X]=Σⱼ₌₁^{T}Pⱼμ′ⱼ=Σⱼ₌₁^{T}Pⱼμₖ=μₖ, the mean of the base capacity.
Case 1: using the q-quantile as reference statistics to scale. The idea of the proof is the same, except that we need to use the definition of the q-quantile.
After scaling, we denote the price distribution for capacity f′ⱼ(x), with its frequency being

$${P}_{j} ≡ \frac{{n}_{j}}{{\sum }_{i = 1}^{T} {n}_{i}} .$$

The distribution of the pooled data can be computed as: f′ₓ(x)=Σⱼ₌₁^{T} Pⱼ f′ⱼ(x), using the Law of Total Probability. We now show that Q_{q}^{k} (the q-quantile of the base capacity k) is again the q-quantile of the aggregated pool distribution.

∫ₓ₌₀^{Q}^{_{q}}^{^{k}}f′ₓ(x)dx=∫∫ₓ₌₀^{Q}^{_{q}}^{^{k}}Σⱼ₌₁^{T}Pⱼf′ⱼ(x)dx=Σⱼ₌₁^{T}Pⱼ[∫∫ₓ₌₀^{Q}^{_{q}}^{^{k}}f′ⱼ(x)dx]=Σⱼ₌₁^{T}Pⱼq=q.
The integral inside the bracket equals q for all capacity type (from 1 through T) by Corollary 1 as all scaled data points of capacity j has identical q-quantile, Q_{q}^{k}.

In conclusion, the previous exposition uses a reference statistics (either mean of a q-quantie) to “normalize” transaction data (of different type) to a base capacity and then uses the same reference statistics to price benchmark. It is equivalent to discarding all transaction data except for the base capacity data—not delivering the purported benefit to enrich the data set.

We now explore the error incurs when the benchmarking statistics is different from the reference statistics. For example, we may use the 15%-quantile as the reference statistics to enrich the data pool and then use it to price benchmark by computing the 25%-quantile of the expanded data pool. If the error term is not too large, perhaps it is an acceptable way to expand the data pool by not ignoring a large quantity of transaction data.

The reason to carry out such error analysis is that many practitioners create an expanded data pool using the scaling scheme and then proceed to compute another statistics in benchmarking—the benchmarking statistics is different from the reference statistics. This section examines the size of such errors.

Suppose we use 15%-quantile as the reference statistics to scale to a base capacity. We now use this expanded data set to compute the 25%-quantile as the benchmark price. Error is introduced because we use the 15%-quantile as a reference statistics to scale and then to compute the 25% quantile to benchmark—similar to scaling the “apples” to compare the “oranges”. Table in FIG. 6 contains error analysis using a hypothetical example. The error is the percentage deviation of the quantile value from the benchmark metric using the same reference statistics (the diagonal terms). This example has 4 different capacities using capacity 1 as the base capacity.

Using this table to illustrate: We wish to compute the 25%-quantile to price benchmark (the last row). If we use the 25%-quantile as the reference statistics to scale (all to capacity 1), we would obtain a value of 33.75.

If we use this expanded data set to compute other quantiles for benchmarking, it will deviate from 33.75 (the last row again), resulting in the accompanying error percentage in the table. For example:

$$\frac{31.91 - 33.75}{33.75} = - 5.46 \% .$$

Similar analysis can be carried out with a different base capacity, leading to different error percentages.

This error will be compounded if we similarly scaled other price elements (for example, transport capacity as well as access capacity).

We now summarize the flaws in the Scaling Method to Expand the Pool of transaction data: Throwing away data: The scaling method (choosing a reference statistics and a base capacity) is meant to include data of all capacities, thus expanding the data set. However, this method is equivalent to using only the base capacity data (while throwing away all other data) if the benchmarking statistics is the same as the reference statistics used in scaling. Substantial errors are present when the benchmarking statistics is different from the reference statistics: This percentage error can range±5-6% with only one price element (e.g., access capacity). The error term will be compounded when additional price elements (e.g., transport capacity and/or routers) are included in bundle price benchmarking. Using the mean value as a reference statistics to scale data to a chosen base capacity will provide a different expanded data set, with its mean value equaling the mean value of the chosen base capacity. However, we will not be able to carry out error analysis since the common practice is to use (some) quantile value to benchmark.

Another competing bundle price benchmarking practice uses a Component Based Model (CBM). To overcome insufficient transaction data for similar/identical WAN bundle. The CBM computes statistics of transaction data for each component in the bundle and then combine the component statistics to arrive at a bundle price benchmark. The common approach is to first compute the q-quantile (e.g., q=20%) of the transaction prices of each bundle component. The sum of the component quantiles will be used as the full bundle price benchmark, representing the q-quantile of the transaction bundle prices. The advantage of this approach is that one can use a dataset that is more in line with what is available in practice—it does not have to come as a bundle price.

A major drawback to use the CBM is that the sum of the component price q-quantiles is generally less than the q-quantile of the sum of component prices (which is the correct quantile from the Full Cost Comparator Model if sufficient data is reliably available). The standard deviation of the sum of random variables is generally smaller than the sum of the individual standard deviations. We will explore the implication of this inequality, which impacts the quantile values: the q-quantile of the sum is generally larger than the sum of the individual quantiles.

The sum of component q-quantiles generally underestimates the q-quantile of the sum of component prices because of the Schwarz's Inequality: a+b+c>\sqrt{a²+b²+c²} as applied to the impact on the standard deviation of the sum of random variables. We now mathematically demonstrate this fact and motivate the need as well as the foundation for our invention.

We will use X, Y and Z to represent the prices of the respective components, which are random variables with respective means and standard deviations: μₓ, μ_{y}, μ_{z} and σ_{X}, σ_{y}, σ_{z}. We denote T=X+Y+Z, the sum of the component prices. We also denote the correlation coefficients between component prices by ρ_{XY}, ρ_{YZ}, ρ_{ZX}. The standard deviation of the sum, T, can be expressed as a function of the component standard deviations and their correlation coefficients: σ_{T}=\sqrt{σₓ²+σₓ²+σₓ²+2ρ_{XY}σ_{X}σ_{Y+}2ρ_{YZ}σ_{Y}σ_{Z}+2ρ_{ZX}σ_{Z}σ_{X}} When X, Y and Z are independent (or when they are uncorrelated: zero correlation coefficients), σ_{T}=\sqrt{σₓ²+σₓ²+σₓ²}<σ_{X}+σ_{Y}+σ_{Z} follows from the Schwarz's inequality. On the other hand, the following inequality in standard deviation holds with (appropriately) negative correlation coefficients:

σ_{T}=\sqrt{σₓ²+σₓ²+σₓ²+2ρ_{XY}σ_{X}σ_{Y+}2ρ_{YZ}σ_{Y}σ_{Z}+2ρ_{ZX}σ_{Z}σ_{X}}<\sqrt{σₓ²+σₓ²+σₓ²}<σ_{X}+σ_{Y}+σ_{Z}

For technical reason, we use the term “appropriately negative”, meaning that the correlation coefficients cannot be arbitrary. When the random variables are positively correlated (sufficiently), the inequality can be reversed (or less significant).

For “similar” distributions (e.g., the normal family, exponential random variables, uniform random variables), the quantile value is (one-to-one) related to its mean by the standard score: the number of standard deviations from its mean. For example, the 20%-quantile of a normal random variable is 0.8416 standard deviations below its mean; while the 15%-quantile is 1.036 standard deviations below its mean. FIG. 7 contains a table showing other typical correspondences between the q value and the number of standard deviations from the mean of a random variable.

For random variables (in this case, the family of normal random variables), with identical means, the q-quantile value (with q less than 50%) becomes larger with smaller standard deviation. It is similar for random variables in the same family (gamma, beta, uniform, etc.). For example, for the same 20%-quantile and with identical mean of 80, the 20% quantiles goes from 54.75 to 71.58 when the standard deviation decreases from 30 to 10—all 20%-quantile is 0.8416 standard deviation below the mean of 80.

For the same family of distributions (e.g., normal) if the sum of the individual standard deviations equal the standard deviation of the sum, the sum of the individual q-quantiles would equal the q-quantile of the sum. This can occur when the random variables are sufficiently positively correlated—the Schwarz's Inequality is compensated by the positive covariances (or equivalently, positive correlation coefficients). Since the standard deviation of the sum is generally smaller than the sum of the individual standard deviations, the q-quantile of the sum would be larger than the sum of the individual q-quantiles, thus the underestimation using the (pure) component based model.

The Full Cost Comparative Model suffers from insufficient transaction data for similar/identical bundles. Scaling method to expand transaction date set results in ignoring many data point. The Component Based Model usually underestimates the quantile value (which is used for price benchmarking) of the bundled WAN services when the sum of component quantiles is used as a proxy.

The present invention is a methodology and process to provide an accurate and transparent price benchmark for bundled product with bundled WAN products/services as one embodiment of the invention. This methodology and process eliminates the flaws inherent in the Full Cost Comparator Model (lack of sufficient transaction data for similar bundles and the flaws in scaling to expand data base) and the Component Based Model (as the sum of component price quantiles underestimates the quantile of the sum of component prices). The resultant price benchmark will be fair, based on past transaction data of similar bundles, to both the suppliers (carriers) and customers (corporate enterprises).

The present invention provides two controlled parameters for the counterparties (suppliers and customers) in a two-step process. Step one establishes the quantile value for mutually agreed-upon price benchmark level. Step two eliminates outliers to adjust for the inherent underestimation in the Component Based Model.

The two-step process will be shown to be equivalent to the one-step Boost-the-q-quantile method in which the outlier elimination step is combined with the established q-quantile to arrive at an equivalent effective quantile of the component transaction prices.

The invention provides a methodology and process to arrive at a fair benchmark price for bundle services, particularly in the context of WAN products/services.

The resultant bundle benchmark price is transparent and reproducible once the collection of historical transaction prices are established, with each component price dataset being processed one at a time.

### SUMMARY OF THE INVENTION

In accordance with at least one aspect of the present invention a system is described for providing a methodology and process to compute a pricing benchmark for bundled products and services. FIG. 8 shows the various components of the system. The exact interactions of system component and the associated mathematics are described in the Detailed Description of the Preferred Embodiments Section.

FIG. 8 represents one embodiment of such a system which includes: (1) transaction price data base for the three (network) elements, (2) Data Trimming Module, (3) Quantile Calculation Module (Engine) and (4) the combination of trimmed transaction price quantiles; arriving at a bundle benchmark price. The number of (network) elements in FIG. 8 can be generalized to any number.

The three Transaction price data bases, as in the preferred embodiment of the invention, represent recent transaction price information for each of the WAN network elements, which are similar in nature and in the proximate geographical location as the WAN contract under consideration. The data points in each of the three transaction price data bases are sorted from low to high. The data points in each network element transaction prices will be represented as a random variable A, with distribution/histogram ƒ_{A}(.).

FIG. 9 shows the Data Trimming Module which requires user input to specify the trimmed parameter, expressed in percentage term. For example, 15%. This module will discard the lowest 15% of all transaction prices in each of the three network elements transaction price database.

After discarding the lowest t % (e.g., t %=15%) of transaction prices, the Data Trimming Module normalizes the remaining transaction prices data to reach a legitimate probability histogram/distribution of transaction price, denoted as ƒ_{B}(.) for a new random variable B. The random variable B has identical distribution of that of random variable A except that the lowest t % of the values of A has been discarded. The distribution ƒ_{B}(.) is the truncated ƒ_{A}(.) and subsequently normalized to represent a legitimate histogram/distribution.

FIG. 10 shows the Quantile Engine which requires user input to specify a q-quantile value, expressed in percentage term, e.g., q %=20%. This engine will calculate the q-quantile of a dataset containing a sorted list of numbers, in particular, a sorted list of prices.

In this particular embodiment of the invention, the following process is prescribed to price benchmark bundled products and services, as specified in FIG. 8 and with its component modules further detailed in FIGS. 9 and 10.

In this particular embodiment, there are three components in the negotiated contract WAN bundle, which can be generalized into any number of components in the bundle.

Transaction price data is used for each component of similar characteristics (as a stand-alone data base one component at a time) to provide a sorted list of prices (for each component).

A trimmed parameter is determined (in percentage terms), denoted as t %.

The lowest t % of the transaction price in each of the three price database is discarded through the Data Trimming Module.

The truncated (discarding the lowest t % of prices in each component price dataset) and sorted dataset and a q-quantile parameter is fed into the Qualtile Engine, which computes the q-quantile of the input dataset: returning the smallest transaction price which is larger than q % of the input dataset.

The sum of the three modified q-quantiles is used as the (quantile based) bundle price benchmark. The modified q-quantile addresses the issue of price underestimation as concluded in [0061].

The three (modified) q-quantile values (output of the Quantile Engine) will be added to provide a price benchmark for the bundled WAN service.

FIG. 11 shows an equivalent embodiment of the invention identical in function and result as that depicted in FIG. 8. This equivalent embodiment of the invention does the following:

Compute the effective q-quantile of each individual component transaction price dataset by combining the trimmed parameter (t %) with the input quantile (q %) to arrive at an effective (modified) quantile: q⁺=t %+q %*(1−t %). The q⁺-quantile of the (original) price dataset (for each component) will be called the Effective q-qualtile after at % truncation, or simply the effective quantile: Q_{q+}=EQ_{q}.

The computed q-quantile of each transaction price dataset, which will be larger than the original q-quantile.

Add the three effective q-quantiles to arrive at a quantile-based bundle benchmark price.

In this particular embodiment, a quantile-based approach is used for price component price benchmarking. An alternative embodiment is to use a different statistics to price benchmark, such as the mean (or average) of transaction prices.

We will show that the procedures in FIG. 8 and FIG. 11 will result in identical bundle benchmark price (using the same three transaction price dataset).

The computed bundle benchmark price enjoys the following advantages over the Full Cost Comparator and the Component Based Model.

Advantage one: the Modified Component Based Model uses individual component transaction price database, which overcome the curse of dimension: it does not have to use transaction prices of bundled WAN services with similar/identical characteristics, as such data is not available [0006], [0007] and [0008].

Advantage two: the Modified Component Based Model does not have to expand transaction price database by scaling to provide a large enough database to ensure statistical significance since it considers transaction data one component at a time.

Advantage three: the Modified Component Based Model corrects for the simple minded approach of the traditional Component Based Model when the bundled benchmark price is computed by adding the component q-quantiles of each transaction price components. The invention adjusts for the underestimation of the price benchmark.

### BRIEF DESCRIPTION OF TABLES AND DRAWINGS

For the purposes of illustrating the various aspects of the invention, there are shown in the drawings forms that are presently preferred, it being understood, however, that the invention is not limited to the precise arrangements and instrumentalities shown.

FIG. 1 contains a table showing the complexity of data need to create a reliable and statistical significant (large enough) data set to cover the combination of three elements in a WAN service with similar characteristics.

FIG. 2 shows the unit capacity price distribution for products with different capacities, with an accompanying table showing selected statistics (mean and 20%-quantile) of the price distribution of each capacity, their respective transaction volume represented in the database as well as the computed scaling constants.

FIG. 3 is a table showing the scaling constants needed to normalize transaction price data from one capacity to a selected base capacity. The scaling process normalizes transaction prices for different capacities to a common reference (user pre-determined quantile) quantile identical to that of the base capacity.

FIG. 4 shows the scaled distributions (after scaling) for four hypothetical price distributions with different capacities.

FIG. 5 is the aggregated price distribution taking into account the volume/size of transaction data for different capacities. The individual scaled price distributions are also shown in the same figure.

FIG. 6 is a table showing the error incurred when the benchmarked quantile is different from the reference quantile.

FIG. 7 shows a table relating the q-value and the number of standard deviations away from the mean of a Normal Random Variable.

FIG. 8 shows the structure/architecture of the Price Benchmarking Methodology and Process.

FIG. 9 shows a schematic of the Data Trimming Module/Engine, which takes as its input a transaction price dataset and a trimmed parameter t. The output is a truncated dataset discarding the lowest t-% of its data.

FIG. 10 shows a schematic of the Quantile Evaluation Engine, which takes as its input a sorted list of numbers (in our conceptual model, a list of sorted transaction price data) and a q-quantile value (e.g., q-%=20%). The module computes the q-quantile of the list of sorted numbers. The q-quantile is the smallest number in the sorted list, which is larger than at least q-% of the data in the list.

FIG. 11 shows an equivalent way to arrive at the same bundle price benchmark (of FIG. 8) by combining the trimming parameter with the (original) quantile value, which computes an effective q-quantile for the original transaction price dataset.

FIG. 12 shows the input and output of the Trimmed Module, using the stylistic distribution for a hypothetical random variable A (the black curve as the input transaction price dataset) and the resultant normalized distribution for the trimmed random variable B (the dash red curve as the output processed transaction price dataset). Note that the area under the individual black and the red curves equals one.

FIG. 13 shows both the distribution of the original transaction price dataset and the trimmed (discarding the lowest t % of the transaction prices) distribution.

FIG. 14 shows the input and output of the Quantile Engine/Module, using the stylistic distribution for a hypothetical random variable B (which is the truncated distribution of the random variable A after discarding the lower t-quantile of the transaction price dataset) to return the q-quantile of the trimmed distribution.

FIG. 15 shows (1) the q-quantile of original distribution of the random variable A, (2) the q-quantile of the trimmed/truncated distribution of the random variable B, and (3) the equivalent (to 2) q⁺-quantile of the random variable A representing the original transaction price dataset.

FIG. 16 shows the various polygon distributions used to fit transaction price data.

FIG. 17 is a table showing three different correlation coefficient matrices used for sensitivity analysis to validate the benchmarking methodology and process/procedure.

FIG. 18 is a table showing the accuracy of the Modified Component Based model with the three representative correlation coefficient matrices shown in FIG. 17. Sensitivity analysis is also carried out with varying coefficient of variation (the ratio of Standard Deviation to the Mean of a distribution).

FIG. 19 shows the Linear Interpolation Module to compute the exact quantile value.

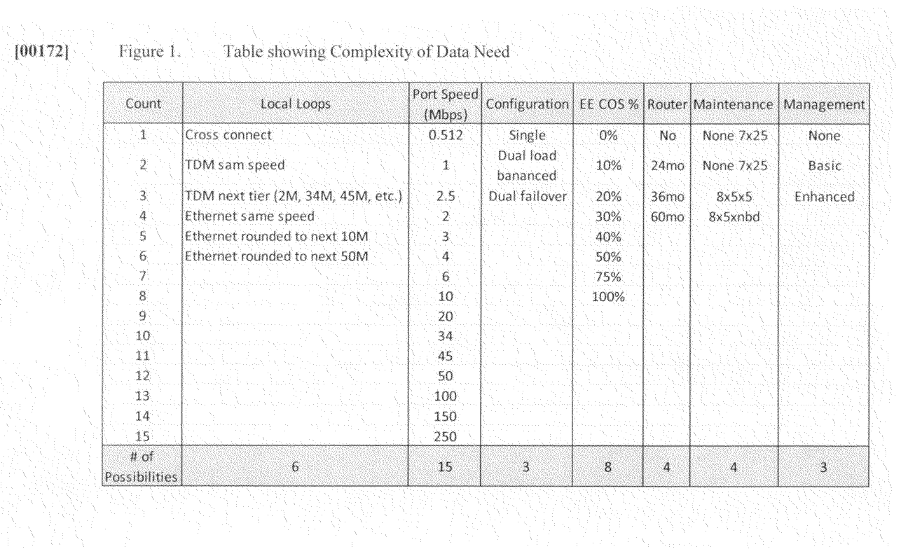

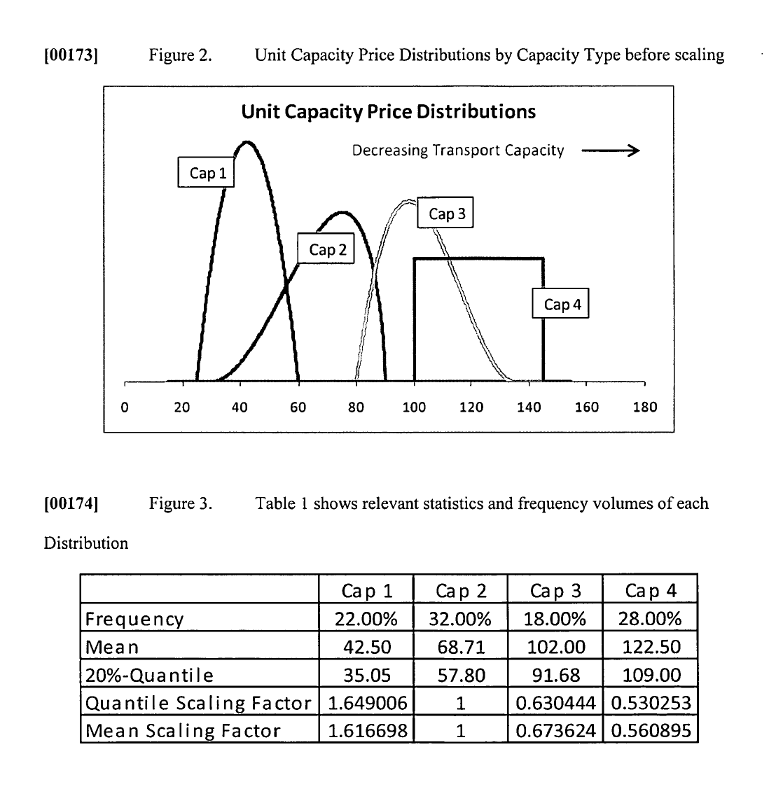

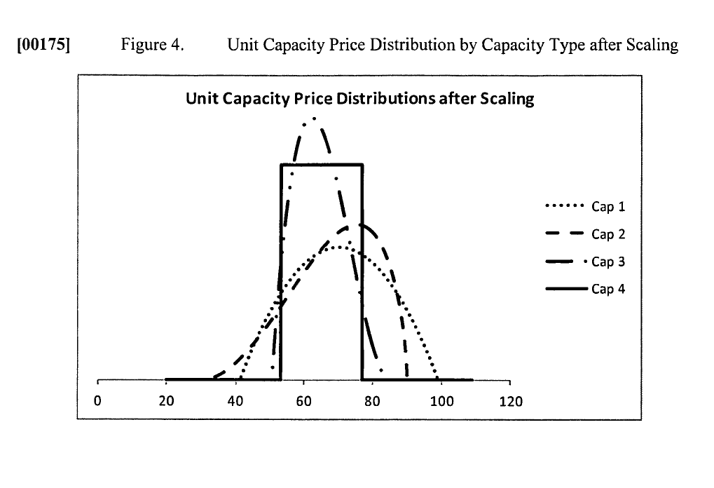

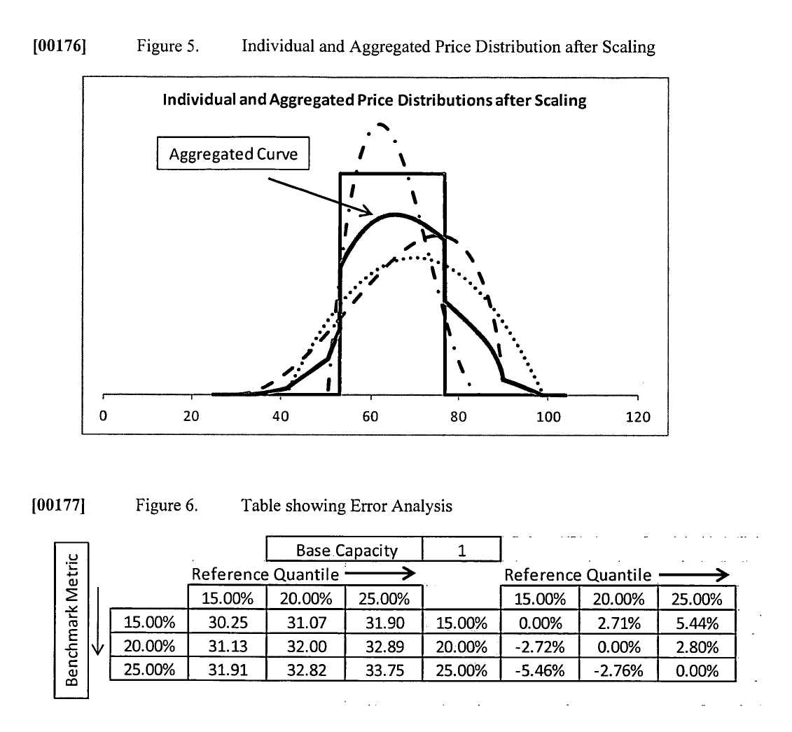

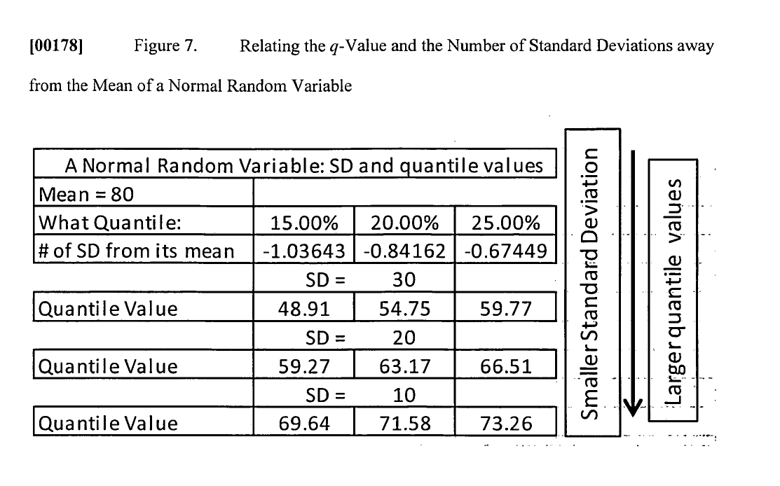

### DETAILED DESCRIPTION OF THE PREFERRED EMBODIMENT

In the following description, for the purposes of explanation, specific numbers, materials and configurations are set forth in order to provide a thorough understanding of the invention. It will be apparent, however, to a person of ordinary skill in the art, that these specific details are merely exemplary embodiments of the invention. In some instances, well known features may be omitted or simplified so as not to obscure the present invention. Furthermore, reference in the specification to “one embodiment” or “an embodiment” is not meant to limit the scope of the invention, but instead merely provides an example of a particular feature, structure or characteristic of the invention described in connection with the embodiment. Insofar as various embodiments are described herein, the appearances of the phase “in an embodiment” in various places in the specification are not meant to refer to a single or same embodiment.

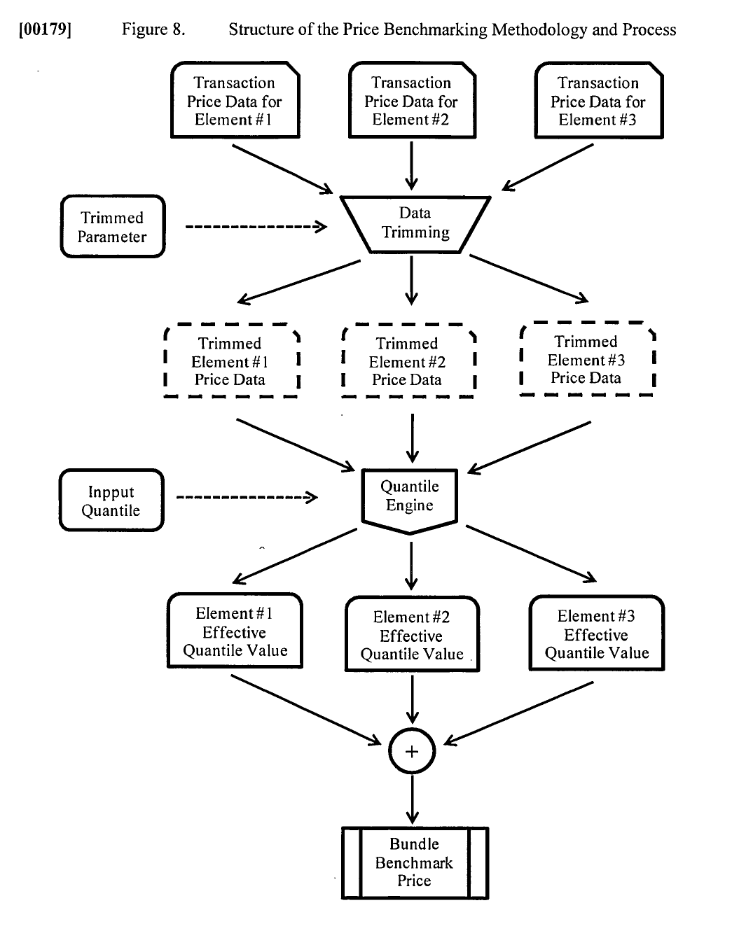

With reference to the drawings, there is shown in FIG. 8 in accordance with at least one embodiment of the Methodology and Process to Price Benchmark Bundled Telecommunications Products and Services.

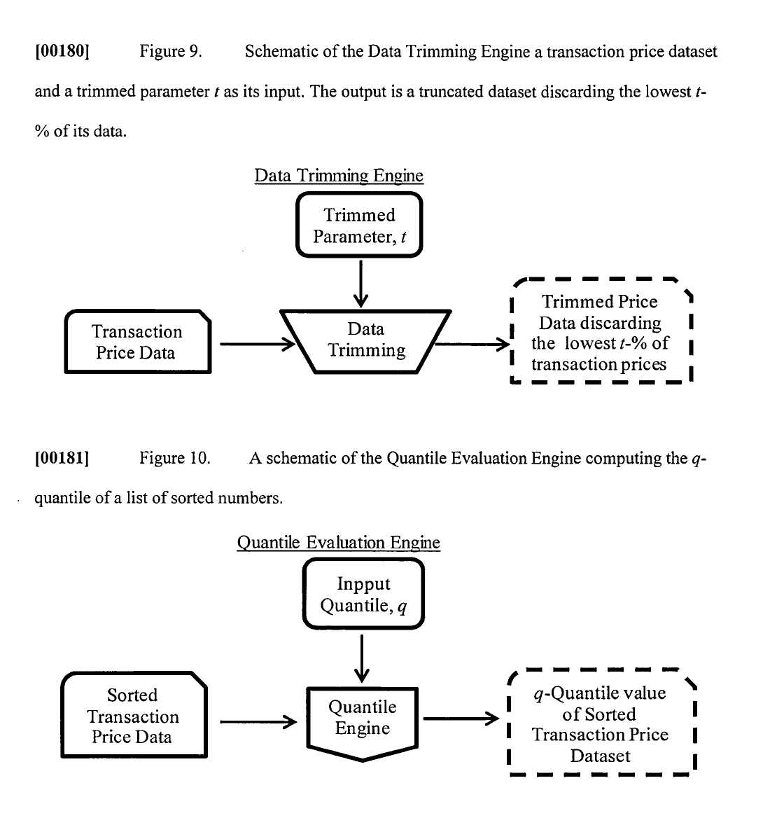

FIG. 9 shows the mechanics of the Data Trimming Module, discarding the lowest P/0 of the transaction price data.

FIG. 10 computes the q-quantile of the truncated transaction price data.

It is instructive (and necessary for the mathematical proof later) to view the original transaction price dataset and its trimmed/truncated dataset as distributions of different random variables. We denote the original transaction price as random variable A with its associated distribution ƒ_{A}(.) and the trimmed transaction price dataset as random variable B with its associated distribution ƒ_{B}(.).

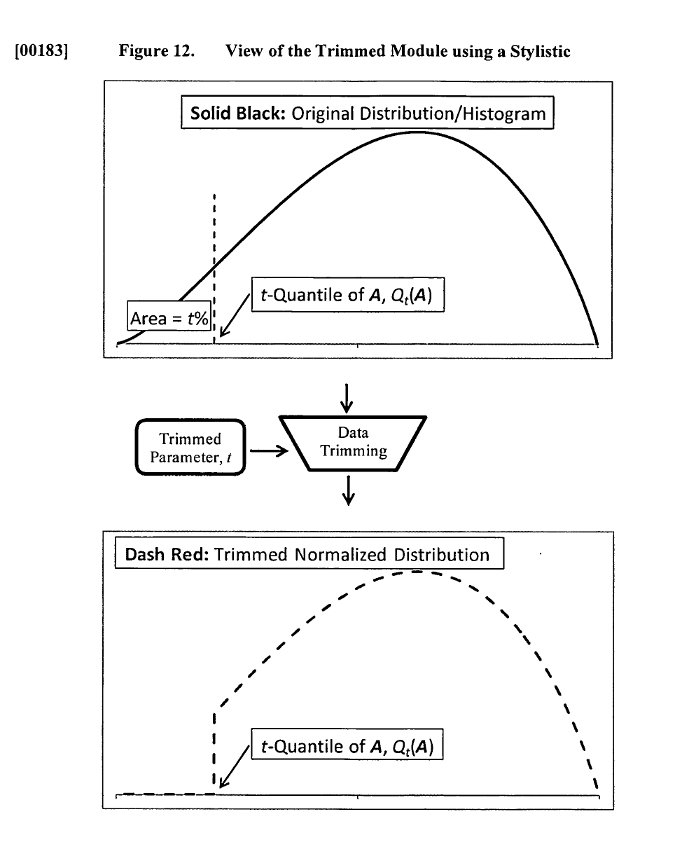

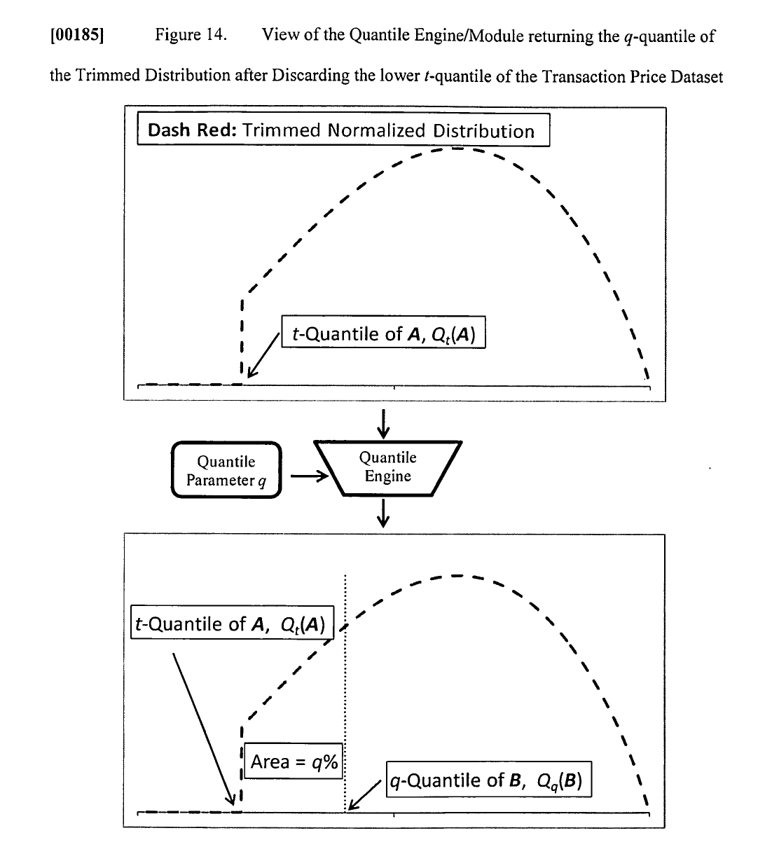

FIG. 12 shows the Trimmed Module in a view relating ƒ_{A}(.) and ƒ_{B}(.), while FIG. 14 shows a similar view of the Quantile Module/Engine.

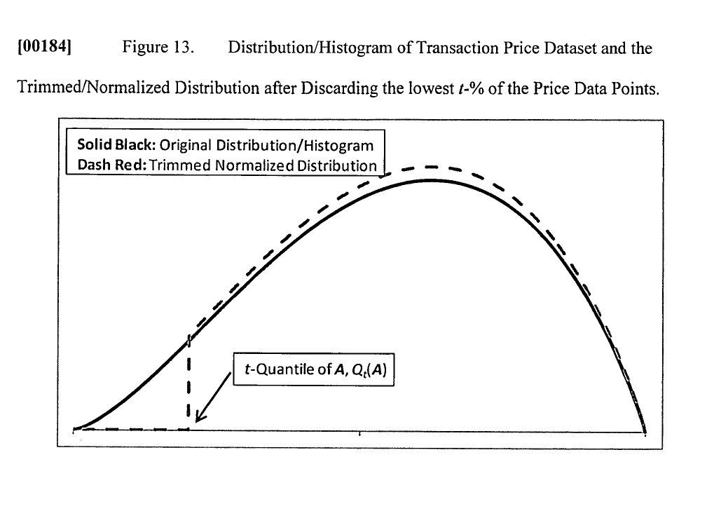

FIG. 13 overlays ƒ_{A}(.) and ƒ_{B}(.) showing their relative shapes, noting that the area under each curve equals one: ƒ_{B}(.) is a scaled version of ƒ_{A}(.) truncating the left tail which represents t % of ƒ_{A}(.).

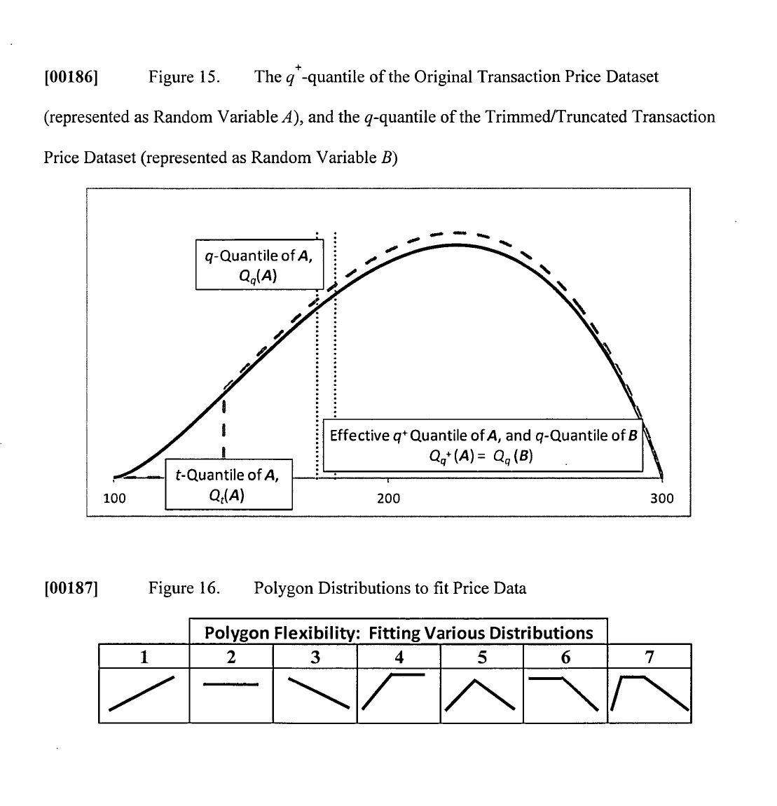

FIG. 15 shows (1) the q-quantile of the trimmed/truncated distribution of the random variable B, and (2) the q⁺-quantile of the random variable A representing the original transaction price dataset.

q⁺-quantile is “some” quantile of the original transaction price dataset, which is larger than its q-quantile, since the q⁺-quantile value is the q-quantile of the truncated transaction price dataset. The relationship between q⁺-quantile of A and the q-quantile of B is derived next.

Relating the q⁺-quantile of A and the q-quantile of B, using FIG. 15:
Start with a complete set of data points, which is represented by the random variable A, with distribution function ƒ_{A}(x), the solid black curve. Denote its q-quantile as Q_{q}(A). The area under the solid black curve to the left of Q_{q}(A) equals q %.
Eliminate the lowest t % of data points (truncate the left tail of ƒ_{A}(x)) to obtain a new distribution for B, the dash red curve,

$${f}_{B} ( x ) = \frac{{f}_{A} ( x )}{1 - t \%} ,$$

when x≧Qₜ(A) and zero otherwise. Qₜ(A) is the t-quantile of A. The area under the solid black curve to the left of Qₜ(A) equals t %.
Denote the q-quantile of B by Q_{q}(B): the area under the dash red curve to the left of Q_{q}(B) equals q, which is the same as the area under the red curve between Qₜ(A) and Q_{q}(B).

$$\begin{matrix}{q}^{+} ( A ; t , q ) = {\int }_{x = 0}^{{Q}_{{q}^{+}} ( A )} {f}_{A} ( x ) d x \\ = {\int }_{x = 0}^{{Q}_{q} ( A )} {f}_{A} ( x ) d x + {\int }_{x = {Q}_{t} ( A )}^{{Q}_{{q}^{+}} ( A )} {f}_{A} ( x ) d x \\ = t \% + ( 1 - t \% ) {\int }_{x = {Q}_{t} ( A )}^{{Q}_{q} ( B )} \frac{{f}_{A} ( x )}{1 - t \%} d x \\ = t \% + ( 1 - t \% ) {\int }_{x = {Q}_{t} ( A )}^{{Q}_{q} ( B )} {f}_{B} ( x ) d x \\ = t \% + ( 1 - t \% ) * q \% .\end{matrix}$$

The q⁺-quantile of A will be called the Effective q-qualtile after a t % truncation, or simply the effective quantile: Q_{q+}(A)=EQ_{q}(A).

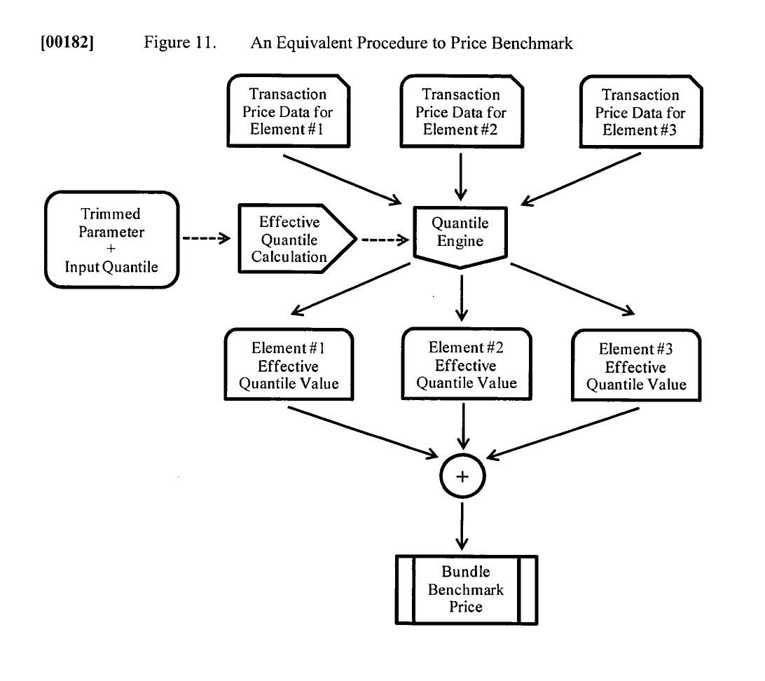

Therefore, the processes depicted in FIG. 8 and FIG. 11 will return the same quantile value of the original transaction price dataset, Q_{q+}(A)=EWA).

The invention adjusts upward the q-quantile of the bundled transaction price to account for issues raised in [0091], Advantage Three of the Modified Component Based Method/Model.

Eliminating the lowest t % of price data, and then compute its q-quantile is equivalent to computing the effective q-quantile (or the q⁺-quantile) of the original dataset.

Therefore, the truncation method effectively boosts the q-quantile to its q⁺-quantile. The sum of the effective q-quantiles of the components will provide a more accurate estimate for the q-quantile of the sum (of the component prices) with an appropriate choice of truncation/trimming factor t-%.

The following factors impact the accuracy of the Modified Component Based Model:

The standard deviation of each component prices

The correlation coefficient between each pair of component prices

The skewness of the distribution of component prices

Sensitivity, numerical and theoretical analyses are performed to assess the robustness and accuracy of the invention using a diverse set of distributions for price points, fitted to represent available data.

Two families of histograms/distributions are used in the investigation: Polygon and Beta Distributions, both of which provide modeling flexibility to fit a diverse possibility of dataset. Linear combinations of these distributions can also be used to provide added flexibility.

FIG. 16 shows the choices of polygon distributions.

Beta distributions are well known. Two parameters of a beta distribution can be fitted to match the mean and standard deviation, and two range parameters to provide a bracket of prices (upper and lower bounds).

To compare the Modified Component Based Model against a Full Cost Comparator Model, a convolution procedure is used to compute the distribution of the sum of random variables—a well know procedure in probability theory.

Convolution procedure is only applicable when the three component prices are independent, or there is zero correlation between the component prices, noting that independence and zero correlation are not equivalent. However, zero correlation is an accurate proxy for independence in practice.

Three different distributions are used to model three distinct component price datasets. A convolution procedure is used to compute the full bundled cost distribution assuming independence of the three prices.

The sum of the three effective q-quantiles (of the three price components) will be compared against the q-quantile of the derived distribution of the sum of the three component prices (result from the convolution procedure), for an appropriate choice of the trim parameter t-%.

To address the impact of price correlation, we use normal distribution for each component prices with various correlation coefficients (in our sensitivity analysis) to examine the accuracy of the Modified Component Based Model. This is necessary since the normal distributions allow for an analytical convolution solution, while no effective procedure is available for other appropriate distributions.

Observation of Sensitivity Analysis assuming zero price correlation between the three component prices:

The lack of sufficient data points precludes the use of the Full Cost comparator model to benchmark market price because it is not reliable to use the quantile estimate.

Pooling data points of different favors (i.e., capacities) by scaling creates errors well in excess of the modified component based model, as examined earlier.

For independent component prices (sufficiently implied by zero correlation), the standard deviation of the bundled price (of the three components) is less than the sum of the standard deviations of the component prices. As a consequence, the sum of the q-quantile of the component distributions is generally less than the q-quantile of the bundled price—the simple component based model underestimates the full cost comparator model.

To compensate for such underestimation, the concept of effective quantile is introduced to boost the individual q-quantile of each component: the effective quantile is higher than the q-quantile. The effective quantile approach is equivalent to eliminating an appropriate percentage of the lowest price points (i.e., the lower outliers) and then take the q-quantile of the truncated dataset.

Our numerical analysis use a diverse selection of distribution (normal, beta and polygon) with their parameters fitted to critical statistics of actual price data (mean, standard deviation and ranges).

Our numerical experiments show that the sum of the effective quantiles (of component prices) is well within acceptable error bounds (from less than one percent to four percents) of the q-quantile of the Full Cost comparator model with a 4-5% truncation and a 20-25% quantile parameters.

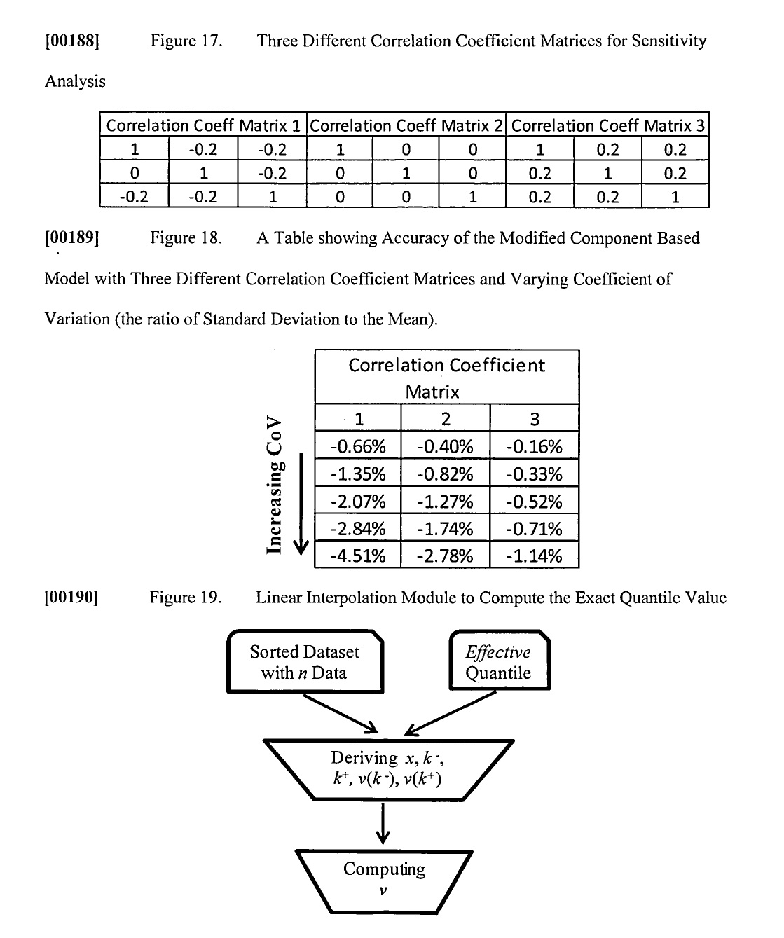

To examine the accuracy of the Modified Component Based Model when the component prices have non-zero correlation coefficients, we used three correlation coefficients matrices shown in FIG. 17.

The following correlation coefficient parameter ranges are examined:

Zero, positive (up to 20%), and negative (as small as −20%) correlation coefficients between component prices.

Sensitivity analysis of the component price standard deviations with coefficient of variation (CoV, ratio of standard deviation to its mean) ranging between 3% and 45%—from a tight distribution to one with wide spread.

Accuracy observations are contained in a table depicted in FIG. 18, and further articulated below:

We use the zero correlation (Matrix 2) as a base case to observe the impact of price correlation on the accuracy of the component based model (only concerned with underestimation).

When the component prices are negatively correlated (Matrix 1), the component based model underestimates the 25%-quantile from a low of −0.66% (low CoV) to a high of −4.51%.

When the component prices are positively correlated (Matrix 3), the component based model underestimates the 25%-quantile from a low of −0.16% (low CoV) to a high of −1.14%—with the base case somewhere in-between (from −0.4% to 2.78%).

In practice, because of the discrete nature of a dataset, it is unlikely that (1) exactly (t %=) 10% of the data points are discarded, and (2) the 25%-quantile corresponds to exactly one particular data point—unlike a (idealized) continuous distribution where one can truncate an exact percentage of data points and identify an exact value for any q-quantile.

A linear interpolation is used to create an exact percentage.

The effective q-quantile method is identical to the two-step (trim/quantile) procedure when the price distribution is continuous.

The effective q-quantile method is used in conjunction with a linear interpolation technique when dealing with a discrete set of data points. The effective q-quantile is computed as: q⁺%=t %+q %*(1−t %).

Suppose there are n data points, the q-quantile will result in a value of: q⁺% of n (x=n*q⁺%) of n being the quantile point for benchmarking. Suppose x is fractional bracketed by two consecutive integer points k⁻and k⁺. We denote the values of these two data points as: v(k⁻) and v(k⁺), which are the values of the k^{-th} and k^{+th} data point in the sorted (from smallest to largest) dataset with n points. We first note that: x is non-integer and that the following inequalities hold:

$${k}^{-} < x < {k}^{+} and \frac{{k}^{-}}{n} < q \% = \frac{x}{n} < \frac{{k}^{+}}{n} .$$

The q⁺-quantile value of this dataset (with n points) are computed as the weighted combination of v(k⁻) and v(k⁺):

$$v = v ( {k}^{-} ) + \frac{v ( {k}^{+} ) - v ( {k}^{-} )}{{k}^{+} - {k}^{-}} ( x - {k}^{-} ) .$$

FIG. 19 shows the Linear Interpolation Module.

1. A system for providing a transparent and reproducible price benchmark for a bundled product with two or more components, comprising, but not limited to, the following:
(i) a trimming (or truncation) module which takes a sorted set of data points (from low to high) and discarding a user-determined percentage of the data points with the lowest values, specified as t %;
(ii) a Quantile Engine/Module which returns a q-quantile value of the sorted dataset with a user input value q %;
(iii) a Sum Module which sums the individual effective quantiles for each of the component prices;

2. An alternative Effective Quantile Approach consisting of:
(i) an Effective Quantile Calculating Module which combines the trimmed parameter t % with the quantile value q % to arrive at an effective quantile q⁺%
(ii) a Linear Interpolation Module which computes an exact (effective) quantile value from a discrete number of data points using linear interpolation;
(iii) a Sum Module which sums the individual effective quantiles for each of the component prices;

3. The system according to claims 1 and 2, wherein a different statistics (other than quantile value) as a price benchmark for bundled products, while retaining the basic procedure of trimming and statistics evaluation.

4. The system according to claim 1, wherein the probabilistic usage of telecommunication units (voice and/or data) is represented by at least one probability model in which several critical statistics (for examples, including but not limited to average, standard deviation) are captured and used.
